(19) United States
(12) Patent Application Publication
(10) Pub. No.: US 2006/0017951 A1
(43) Pub. Date: Jan. 26, 2006

(54) Data output apparatus, system and method, and printer driver and storage medium

(75) Inventor: Yoshiaki Tanaka, Uji-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/183,871

(22) Filed: Jul. 19, 2005

(30) Foreign Application Priority Data
Jul. 22, 2004 (JP) 2004-214429

(51) Int. Cl. G06F 15/00

(52) U.S. Cl. 358/1.13; 358/1.15

(57) ABSTRACT

Using a single printer driver, the present invention enables setting, for each user, identification information of the user or the group the user belongs to and enables settings information concerning printing of the printer other than the identification information to be shared by multiple users. A data output apparatus is connected to at least one printer via a network, and includes a data send/receive unit communicating with the printer and a printer driver executing settings regarding printing of the printer. The printer driver includes a means for acquiring user information, a means for inputting identification information (e.g., department numbers) for identifying the user or the group the user belongs to, and a means for retaining the inputted identification information in association with the acquired user information, wherein the data send/receive unit communicates the retained identification information to the printer based on the user information acquired at the time of printing.

### CROSS-NOTING PARAGRAPH

This non-provisional application claims priority under 35 U.S.C. §119(a) on Patent Application No. 2004-214429 filed in JAPAN on Jul. 22, 2004, the entire contents of which are hereby incorporated herein by reference.

### FIELD OF THE INVENTION

The present invention relates generally to a data output apparatus, system and method, and a printer driver and a storage medium, and, more particularly, to a data output apparatus, data output system, and data output method for performing output processing of document data or other data, as well as to a printer driver and a storage medium for storing the printer driver.

### BACKGROUND OF THE INVENTION

Conventionally, department numbers for identifying each department in an organization, and user IDs and passwords for user authentication have been required to be inputted beforehand in the host system via the user interface of the printer driver. Input of such department numbers, user IDs, and passwords have generally been carried out for each print job.

Recently, the practice of keeping accounts of records of printer usage (use history information) for each department or for each user has become more and more common. One possible cause is the increasing use of printers with a system for charging by the number of printed sheets and of digital multifunction printers. For example, Japanese Laid-Open Patent Publication No. 2003-6134 discloses a technique for distributing a printer driver having department numbers different for each user. This technique spares the end users the need to set the department code to the distributed printer driver and facilitates the management of printer usage history for each department.

However, in the above Japanese Laid-Open Patent Publication No. 2003-6134, in case that multiple users share a computer, many printer drivers need to be installed on the computer. This means, for example, that changing of option settings information of the printer involves changing of settings of each printer driver (for every user) and thus requires a heavy workload.

Moreover, the conventional method of setting department numbers, user IDs and passwords for user authentication for each job involves an issue as follows.

When print function settings information including department numbers is communicated, some applications retain, in the document, all of the print settings information set by the user who created or saved the document and thus communicate to the printer the department number of the user who created the document even when some other user is printing the document.

### SUMMARY OF THE INVENTION

The present invention was conceived to address such an issue. The objects of the present invention are that, using a single printer driver, the present invention enables setting, for each user, identification information of the user or the group the user belongs to (e.g., department numbers) and at the same time enables settings information concerning printing of the printer other than that identification information to be shared by multiple users, and that, using a single printer diver, the present invention enables setting, for each user, identification information of the user or the group the user belongs to (e.g., department numbers) and at the same time enables the identification information not to be disclosed to other users via applications.

Another object of the present invention is to provide a data output apparatus comprising a communications means for communicating with at least one printer; and a printer driver for establishing settings regarding printing of the printer, wherein the printer driver includes a user information acquisition means for acquiring user information, an identification information input means for inputting identification information for identifying the user or the group the user belongs to, and an identification information retention means for retaining the inputted identification information in association with the acquired user information, and wherein the communications means communicates to the printer the identification information retained in the identification information retention means based on user information acquired at the time of printing.

Another object of the present invention is to provide the data output apparatus which may further comprise an application means for executing a specified function, and wherein the identification information retention means may retain the identification information in a specified storage area not accessible by the application means.

Another object of the present invention is to provide the data output apparatus where the identification information retention means may retain the identification information in association with device information for each printer and with the user information.

Another object of the present invention is to provide the data output apparatus where the identification information retention means may retain the identification information in association with registration information set in the printer driver and with the user information.

Another object of the present invention is to provide the data output apparatus which may further comprise an application means for executing a specified function, and wherein the printer driver may include an application communication means for communicating to the application means print settings information of the printer with leaving the identification information blank.

Another object of the present invention is to provide the data output apparatus where the identification information retention means may retain the identification information in association with device information for each printer or with registration information of the printer driver at the time of installing the printer driver.

Another object of the present invention is to provide the data output apparatus where the printer driver may include a means for displaying a screen for the input of identification information at the time of printing in case the identification information retained in the identification information retention means can not be acquired, and wherein the identification information retention means may retain the identification information inputted from the screen for each user.

Another object of the present invention is to provide the data output apparatus where the identification information retention means may retain the identification information for each user in association with both device information for each printer and registration information of the printer driver, and in case that the identification information retained in association with the registration information of the printer driver and with the user information can not be acquired, the identification information retention means may retain, in association with registration information of the printer driver and with the user information, the identification information retained in association with device information for each printer and with the user information.

Another object of the present invention is to provide the data output apparatus where the printer driver may include a means for authenticating a user who has the authority of managing the printer and a means for displaying, for the authenticated user, a screen for the input of identification information of all users, and the identification information retention means may associate identification information inputted from the screen with the user information and retain the identification information inputted from the screen in association with device information for each printer or with registration information of the printer driver.

Another object of the present invention is to provide a data output apparatus comprising a printer driver for establishing settings regarding printing of at least one printer; and an application means for executing a specified function, wherein the printer driver includes a user information acquisition means for acquiring user information, an identification information input means for inputting identification information for identifying the user or the group the user belongs to, an identification information retention means for retaining the inputted identification information in association with the acquired user information, and an application communication means for communicating to the application means print settings information of the printer with leaving the retained identification information blank.

Another object of the present invention is to provide a data output system where a data output apparatus and a management server apparatus are connected to each other, and where the data output system comprises the data output apparatus provided with a printer driver which communicates with at least one printer and establishes settings regarding printing of the printer; and the management server apparatus retaining identification information for each user for identifying the user or the group the user belongs to, wherein the printer driver includes a means for acquiring user information, a means for sending the acquired user information to the management server apparatus, and a means for acquiring, from the management server apparatus, the identification information corresponding to the sent user information, and wherein the printer driver acquires, from the management server apparatus, the identification information corresponding to user information acquired at the time of printing and communicates the identification information corresponding to user information to the printer.

Another object of the present invention is to provide a data output method using a printer driver which communicates with at least one printer and establishes settings regarding printing of the printer, wherein the data output method comprising the steps of acquiring user information; inputting identification information for identifying the user or the group the user belongs to; retaining the inputted identification information in association with the acquired user information; and communicating the retained identification information to the printer.

Another object of the present invention is to provide a data output method using a printer driver which communicates with an application means for executing a specified function and establishes settings regarding printing of at least one printer, wherein the data output method comprising the steps of acquiring user information; inputting identification information for identifying the user or the group the user belongs to; retaining the inputted identification information in association with the acquired user information; and communicating to the application means print settings information of the printer with leaving the retained identification information blank.

Another object of the present invention is to provide a data output method in a system where a data output apparatus and a management server apparatus are connected to each other, and which includes the data output apparatus provided with a printer driver communicating with at least one printer and establishing settings regarding printing of the printer and the management server apparatus retaining, for each user, identification information for identifying the user or the group the user belongs to, wherein the data output method comprising the steps of acquiring user information; sending the acquired user information to the management server apparatus; acquiring, from the management server, the identification information corresponding to the sent user information; and communicating to the printer the acquired identification information.

Another object of the present invention is to provide a printer driver for executing functions as the data output apparatus.

Another object of the present invention is to provide a printer driver for executing functions as the data output apparatus in the data output system.

Another object of the present invention is to provide a computer readable storage medium having stored the printer driver.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 shows an example of configuration of a data processing system concerning one embodiment of the present invention;

FIG. 2 is a block diagram showing an example of module configuration of the printer driver shown in FIG. 1;

FIG. 3 is an example of an identification information input screen displayed on a screen by an identification information input unit;

FIG. 4 is an example of an option setting screen displayed on a screen by a printer driver function setting unit;

FIGS. 5A and 5B are flowcharts for illustrating one example of a data output method to which the present invention is applied;

FIG. 6 is a flowchart for illustrating another example of a data output method to which the present invention is applied;

FIG. 7 shows an example of configuration of a data output system according to other embodiment of the present invention; and

FIG. 8 is a flowchart for illustrating another example of a data output method to which the present invention is applied.

### DESCRIPTION OF THE PREFERRED EMBODIMENTS

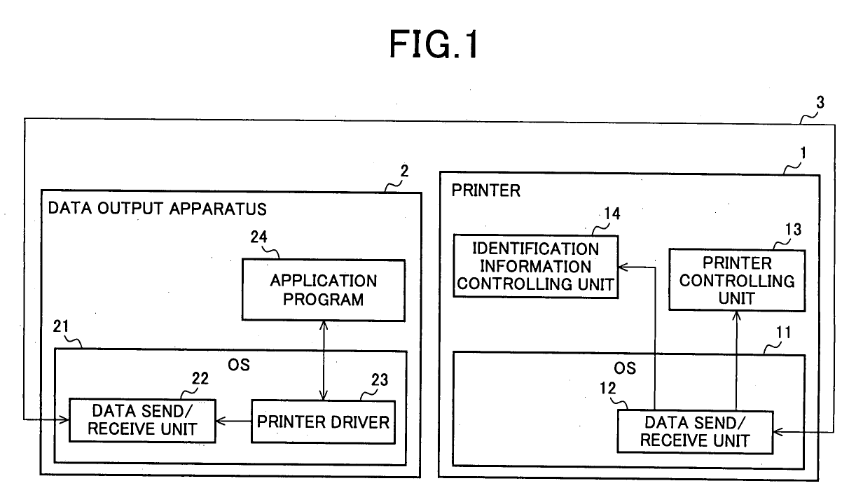

FIG. 1 shows an example of configuration of the data processing system concerning one embodiment of the present invention. In the figure, reference numeral 1 denotes a printer comprising an OS (operating system) unit 11, a data send/receive unit 12, a printer controlling unit 13, an identification information controlling unit 14; reference numeral 2 denotes a data output apparatus comprising an OS unit 21, a data send/receive unit 22, a printer driver 23, an application program 24. The printer 1 and the data output apparatus 2 are connected via a network 3. While in this example the data output apparatus has only one printer 1 connected to it, a plurality of printers 1 may be connected with the data output apparatus via the network 3.

The above data output apparatus 2 is an information processing apparatus comprising a general-purpose personal computer (PC) provided with a CPU controlling the whole device, RAM and ROM, which are semiconductor memories, a storage device such as HDD (hard disk drive), an input device, a display device, a communication device, an output device, a system bus (not shown in the figure) and etc. The printer driver 23 is a program provided with a function for establishing settings regarding printing of the printer 1, a function for establishing settings of identification information of users or the groups the users belong to, and the like. This printer driver 23 enables the information processing apparatus to function as the data output apparatus 2 of the present invention. The printer driver 23 is installed on a storage device such as an HDD and works on the OS unit 21. At the time of performing the printing, the print operation is performed through the CPU's loading of the printer driver 23 to the RAM, which serves as a working area.

The status of the process still in progress and the result of the process are shown to the operator and the like through a display device such as CRT or LCD. In each process, the operator inputs and specifies necessary parameters and the like with an input device such as a keyboard or a mouse (a pointing device). And the communication device is a network interface for connecting to various kinds of data communications networks, which provides connection between information processing devices with making them accessible each other. The output device connects to an external device such as a printer and outputs. These CPU, RAM, ROM, storage device, input device, display device, communication device, and output device are interconnected via the system bus.

In the printer 1 shown in FIG. 1, the OS unit 11 is an operating system for controlling various functions of the printer 1, and is provided with a data send/receive unit 12 for sending data to or receiving data from the data output apparatus 2, and, via this data send/receive unit 12, sends controlling signals to the printer controlling unit 13 which controls the functions of the printer 1, while sending controlling signals to the identification information controlling unit 14 which controls identification information of users or the groups the users belong to.

And, in the data output apparatus 2, the OS unit 21 is an operating system for controlling various functions of the data output apparatus 2, and is provided with a data send/receive unit 22 for sending data to or receiving data from the printer 1, and a printer driver 23 which establishes the settings of identification information of users or the groups the users belong to and settings concerning printing of the printer 1. The printer driver 23 communicates to the printer 1 the settings of identification information of a user or the group the user belongs to, and communicates to the application program 24, which execute a specified functions (e.g., document authoring function or spreadsheet calculation function), print settings information including the above identification information. This print settings information is various settings information concerning printing, and includes print function settings information and option settings information, and is information for setting, for example, print quality (dpi), zoom function, or the number of pages to be printed per sheet. And, the identification information of the user or the group the user belongs to may be, for example, a department number of the department the user belongs to (consisting of numbers, alphabets, symbols, characters, or possibly combinations thereof) or a user identification ID and a password for user authentication.

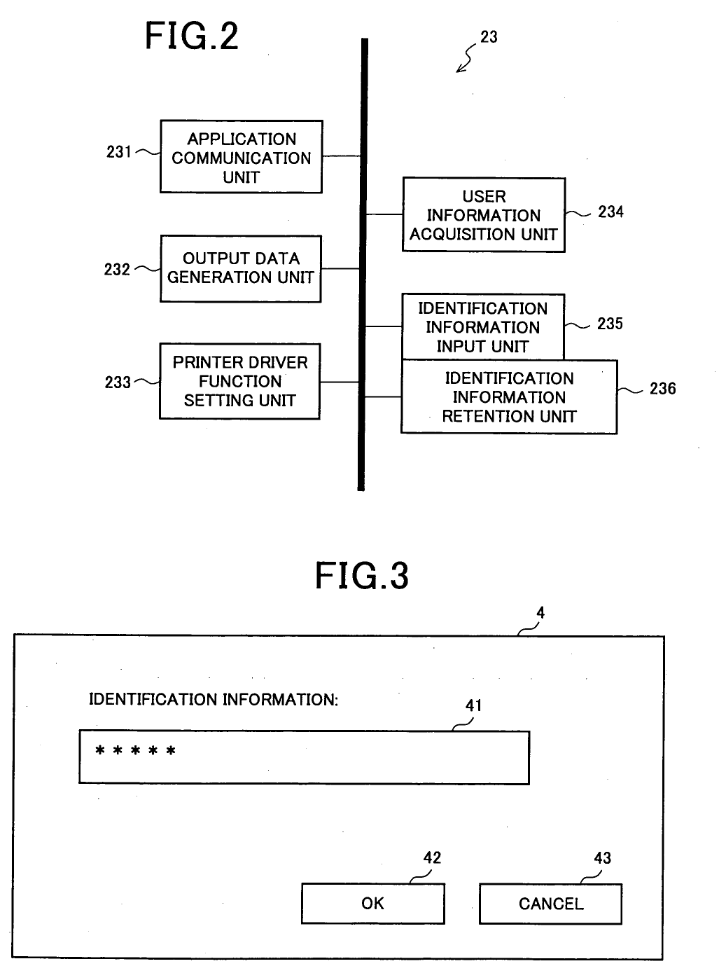

FIG. 2 is a block diagram showing an example of module configuration of the printer driver shown in FIG. 1. The printer driver 23 is provided with an application communication unit 231, an output data generation unit 232, a printer driver function setting unit 233, a user information acquisition unit 234, an identification information input unit 235, and an identification information retention unit 236. This printer driver 23 is a program for performing the functions as above means, stored on a storage device such as HDD, and loaded into RAM as a working area and executed by the CPU.

The application communication unit 231 is a means for communicating with the application program 24. The output data generation unit 232 is a means for converting the document data and the like acquired from the application program 24 into output data. The printer driver function setting unit 233 is a means for establishing settings concerning printing of the printer 1 and sets print function settings information of the printer 1 (e.g., print quality (dpi), zoom function, or the number of pages to be printed per sheet) and option settings information (e.g., presence of a finisher attached to the printer 1 or selection of stapling options).

The user information acquisition unit 234 is a means for acquiring user information and obtains, for example, the login name of the user through a function of the OS unit 21. This can be achieved, for example, by the use of the API (application program interface). The API is a set of commands and functions which can be used when developing the operating system and the like, or a set of rules defining the programming procedure for using such commands and functions. The identification information input unit 235 is a means for inputting identification information for identifying the user or the group the user belongs to. The identification information retention unit 236 is a means for retaining the identification information inputted in the identification information input unit 235 in association with the user information acquired in the user information acquisition unit 234. This identification information is retained in memory. And, the identification information retained in the identification information retention unit 236 is, according to the user information acquired at the time of printing, communicated to the printer 1 by the data send/receive unit 22 in the data output apparatus 2.

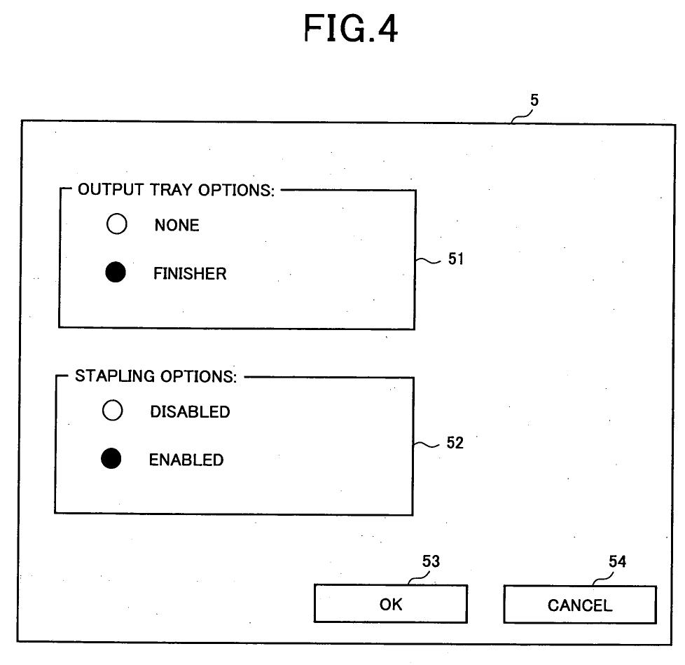

FIG. 3 shows an example of the identification information input screen displayed on the screen by the identification information input unit 235. In this figure, reference numeral 4 denotes the identification information input screen comprising an identification information input field 41, an OK button 42, and a Cancel button 43. The identification information retention unit 236 retains the identification information inputted from this identification information input screen 4 in association with the user information acquired in the user information acquisition unit 234.

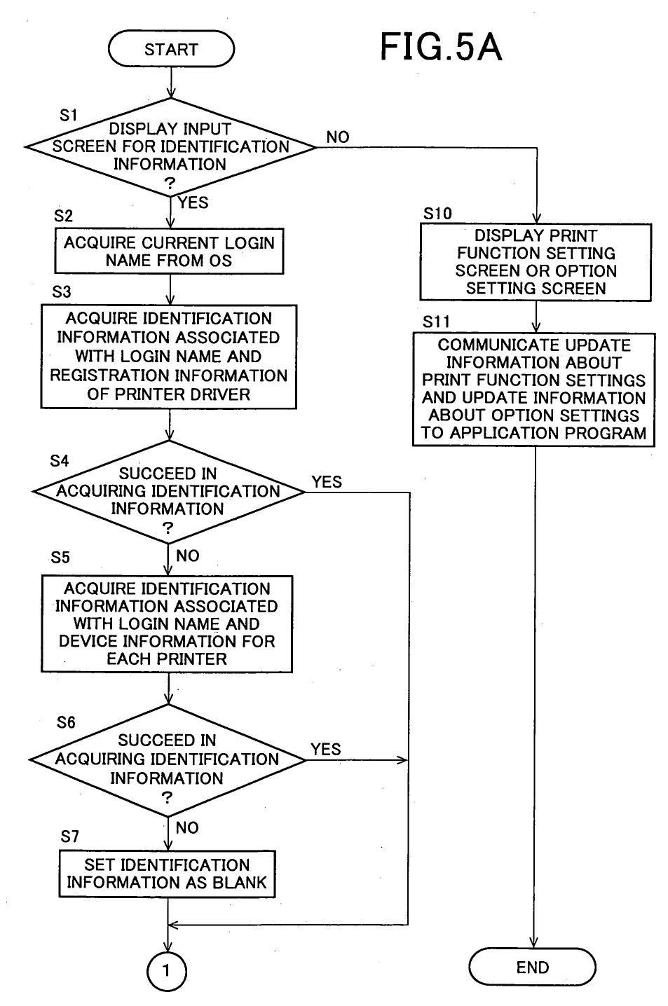

FIG. 4 shows an example of the option setting screen displayed on the screen by the printer driver function setting unit 233. In this figure, reference numeral 5 denotes the option setting screen comprising output tray options 51 for setting the presence or absence of a finisher, stapling options 52 for enabling or disabling the stapling, an OK button 53, and a Cancel button 54.

In this embodiment, installation of a single printer driver on the data output apparatus enables setting, for each user, identification information for identifying of the user or the group the user belongs to and at the same time enables print function settings information or option settings information (e.g., presence of a finisher attached to the printer or selection of stapling options) of the printer other than the identification information to be shared by multiple users. This facilitates the changing of the print function settings information or option settings information shared by users like the above when one data output apparatus is shared by multiple users and each user belongs to a different department.

In another embodiment, the identification information retention unit 236 may retain the identification information for identifying the user or the group the user belongs to in a specified storage area not accessible by the application program 24, thus making the identification information not accessible from the application program 24. Here, the specified storage area not accessible by the application program 24 is an area such as the registry area on the memory whose specifications are not disclosed.

In case that print settings information including the identification information is communicated to the application program, some application programs retain, in the document, all of the print settings information set by the user who created or saved the document. In such cases, if the document is sent to another user via e-mail and the like and printed by that another user, the identification information of the user who created the document is communicated to the printer. In this embodiment, the identification information is not accessible by the application program and is prevented from being sent to other users. The identification information of the user who created or saved the document is communicated to the printer only by the user himself.

In other embodiment, the identification information retention unit 236 may retain the identification information for identifying the user or the group the user belongs to in association with device information for each printer and user information. Here, the device information for each printer is information including the printer specific identification information and is so set not to be changed easily by users.

Assumed here is a system that has one printer driver and where setting of identification information of each user is different for each printer, as in the case where a printer from the A Corp. allows up to 10 digits for identification information while a printer from the B Corp. accepts only five digits. Even in such a case, associating the identification information for identifying the user or the group the user belongs to with each printer (device information) enables retaining the identification information for each user.

In other embodiment, the identification information retention unit 236 may retain the identification information for identifying the user or the group the user belongs to in association with the registration information set in the printer driver 23 and user information.

Here, printers have usually different names if their printing speeds or option configurations (ejector devices, finishers, etc.) are different, therefore, generally, printer driver corresponding to these printers are united into a single printer driver and that single printer driver supports printers with different registration names. When a plurality of these printers with different registration information are present on the network, a plurality of registration information (such as registration names) can be set for one printer driver. For example, a name such as “Printer on 1st Floor” or “Printer on 2nd Floor” can be assigned to one printer driver.

In this embodiment, when it is desired to set different charging rates according to printer class (names) and the like, and keep accounts at a management server apparatus, setting identification information for each printer (device information of the printer) and for each registration information of the printer driver eliminates the need to identify printers themselves and requires only the setting of charging rates for above identification information, thus facilitating the account keeping.

And, in other embodiment, the application communication unit 231 may communicate the print settings information of the printer 1 to the application program 24 with leaving the identification information for identifying the user or the group the user belongs to blank. Here, leaving the identification information blank includes setting the identification information as “null (no data)” and simply not setting the retained data (the identification information).

As stated earlier, in case that print settings information including the identification information is communicated to the application program, some applications retain, in the document, all of the print settings information set by the user who created or saved the document. In this embodiment, communicating the print settings information to the application program without setting the identification information can prevent the identification information from being disclosed to other users.

And, in other embodiment, the identification information retention unit 236 may, at the time of installation of the printer driver 23, retain the identification information of the user or the group the user belongs to in association with the device information for each printer or the registration information of the printer driver 23.

In this embodiment, identification information for each user can be registered en bloc at the time of installation of the printer driver. Therefore, it is not necessary for each user to input the identification information, thus reducing his burden of typing work.

And, in other embodiment, the printer driver 23 may, in case it cannot acquire the identification information retained in the identification information retention unit 236, be provided with a means for displaying a screen for the input of identification information at the time of printing and the identification information retention unit 236 may retain the identification information inputted from this screen for each user. For example, the identification information input screen shown in FIG. 3 is displayed and the input of identification information is accepted.

In this embodiment, in some cases including the case that identification information is no longer acquired due to some changes in the registration information of the printer driver, it can be communicated to the user by showing the screen for the input of identification information to the user at the time of printing that the identification information is not set. In addition, in case a user deletes the identification information associated with the printer driver and user information by mistake, it can be communicated to the user by showing the screen for the input of identification information to the user at the time of printing that their identification information is not set.

In other embodiment, the identification information retention unit 236 may retain for each user the identification information of each user or each group the user belongs to in association with both the device information for each printer and the registration information of the printer driver 23, and, in case that it cannot acquire the identification information retained in association with the registration information of the printer driver 23 and the user information, may retain, in association with the registration information of the printer driver 23 and the user information, the identification information retained in association with the device information for each printer and the user information.

Here, since the registration information of the printer driver is easily changed by the users, the users may change the registration information (whereas the device information for each printer is set in such a way that users cannot easily change it) by mistake. In this embodiment, by retaining, in association with the registration information of the printer driver and the user information, the identification information associated with the device information for each printer and the user information, occurrence of such an event that the identification information fails to be sent can be prevented even if the user changes the registration information by mistake.

And, in other embodiment, the printer driver 23 may be configured with a means for authenticating a user who has the authority of managing the printer 1 and a means for displaying to the authenticated user a screen for the input of identification information of all users. In this case, the identification information retention unit 236 associates the user information with the identification information inputted from the identification information input screen shown in FIG. 3 and retains the identification information inputted from the identification information input screen in association with the device information for each printer or the registration information of the printer driver 23. As the means for authenticating the user herein stated, such a means as giving the administrator authority in Windows (registered trademark) Xp, etc. can be preferably employed.

Such an embodiment enables changing the settings of identification information by the user with the administrator authority when some change has occurred in identification information, thus eliminating the need for each user to be engaged in the work of changing the identification information.

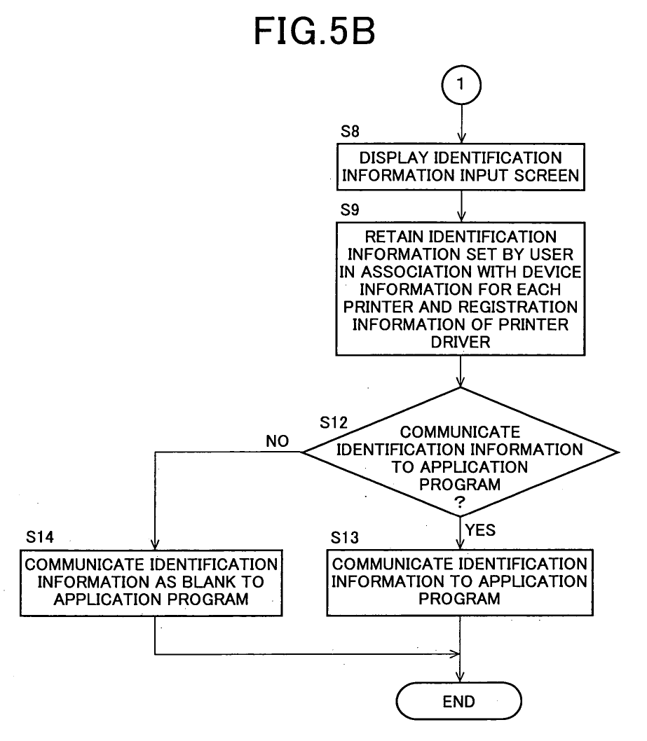

FIGS. 5A and 5B are a flowcharts for illustrating one example of the data output method to which the present invention is applied. This example is to illustrate the flow of the identification information setting process by the printer driver 23 as shown in FIG. 1. First, the data output apparatus 2 decides whether the display of the setting (input) screen for identification information of the user or the group the user belongs to has been required or not (Step S1), and, if it has been required (if YES), acquires the current login name from the OS unit 21 (Step S2) and acquires the identification information associated with the login name and the registration information of the printer driver 23 (Step S3).

Next, the data output apparatus 2 decides whether the acquisition of the identification information has been successful or not (Step S4), and, if the identification information could not have been acquired (if NO), acquires the identification information associated with the login name and the device information for each printer (Step S5). Next, the data output apparatus 2 decides whether the acquisition of the identification information has been successful (Step S6), and, if the identification information could not have been acquired (if NO), sets the identification information as blank (Step S7) and proceeds to Step S8. On the other hand, if the acquisition of the identification information has been successful in above Step S4 and S6 (if YES), the data output apparatus 2 proceeds to display process of the input screen for identification information (Step S8) and retains the set identification information in association with the device information for each printer and the registration information of the printer driver 23 (Step S9).

And, if, in Step S1 described above, the display of the input screen for identification information has not been required (if NO), the data output apparatus 2 proceeds to display process of the print function setting screen or option setting screen (Step S10) and communicates to the application program 24 update information about print function settings and update information about option settings (Step S11).

Next, the data output apparatus 2 decides whether the identification information retained in Step S9 should be communicated to the application program 24 or not (Step S12) and, if it should be communicated to the application program 24 (if YES), communicates the identification information to the application program 24 (Step S13). If, in Step 12 in the above, it should not be communicated to the application program 24 (if NO), the data output apparatus 2 communicates to the application program 24 with leaving the identification information blank (Step S14).

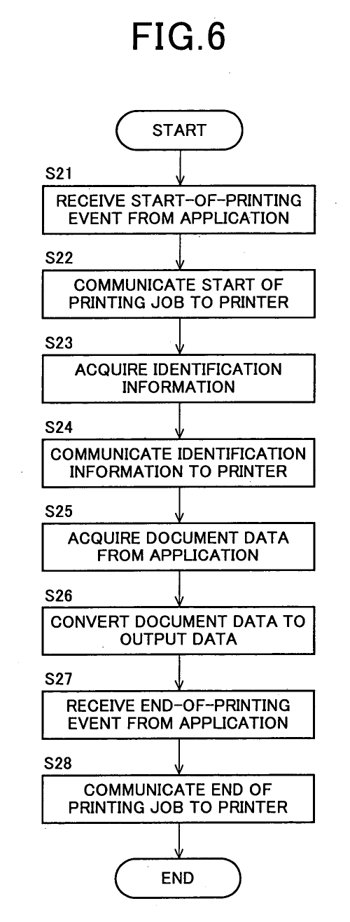

FIG. 6 is a flowchart for illustrating another example of the data output method to which the present invention is applied. This example is to illustrate the flow of the printing process by the printer driver 23 shown in FIG. 1. First, the data output apparatus 2 receives an event of starting the printing from the application program 24 (Step S21) and communicates the start of the printing job to the printer 1 (Step S22) and acquires the identification information of the user or the group the user belongs to (Step S23).

Next, the data output apparatus 2 communicates the acquired identification information to the printer 1 (Step S24), acquires the document data from the application program 24 (Step S25), converts the acquired document data to output data (Step S26), and receives an event of the end of the printing from the application program 24 (Step S27). In the end, the data output apparatus 2 communicates the end of the printing job to the printer 1 (Step S28).

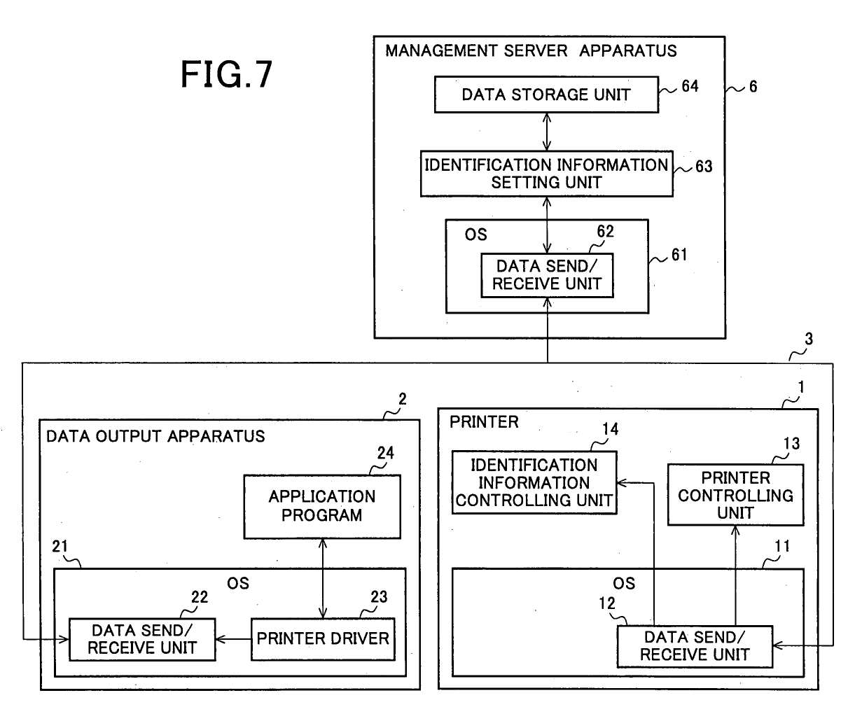

FIG. 7 shows an example of configuration of the data output system according to other embodiment of the present invention. In this figure, in addition to the printer 1 and the data output apparatus 2 shown in FIG. 1, a management server apparatus 6 is connected to the network 3. The management server apparatus 6 comprises an OS unit 61 for managing various functions of the management server 6, a data send/receive unit 62 which communicates with the data output apparatus 2 via the network 3, an identification information setting unit 63 for setting identification information of users or the groups the users belong to, and the data storage unit 64 which retains the set identification information for each user. In this example, the printer driver 23 of the data output apparatus 2 is assumed to be able to communicate with the management server apparatus 6 and acquire identification information from the management server apparatus 6.

Similarly to the data output apparatus 2, the above management server apparatus 6 is an information processing apparatus comprising a general-purpose personal computer provided with CPU, RAM, ROM, a storage device such as HDD, an input device, a display device, a communication device, an output apparatus, a system bus, and etc. not shown in the figure. The status of the process still in progress and the result of the process are shown to the operator and the like through a display device such as CRT or LCD. In each process, the operator inputs and specifies necessary parameters and the like with an input device such as a keyboard or a mouse (a pointing device). And the communication device is a network interface for connecting to various kinds of data communications networks, which provides connection between information processing devices with making them accessible from each other. The output apparatus connects to an external device such as a printer and outputs data. These CPU, RAM, ROM, storage device, input device, display device, communication device, and output apparatus are interconnected via the system bus.

In FIG. 7, the printer driver 23 of the data output apparatus 2 is provided with a means for acquiring user information, a means for sending the acquired user information to the management server apparatus 6, and a means for acquiring, from the management server apparatus 6, the identification information corresponding to the sent user information, and is able to acquire, from the management server 6, the identification information corresponding to user information acquired at the time of printing and communicate the identification information corresponding to the user information acquired to the printer 1.

Such an embodiment enables the centralized management of the identification information of the users or the groups the users belong to for each user by the management server apparatus, so, when, for example, some changes have occurred in identification information, requires nothing more than changing the settings of the management server apparatus side, thus saving the time for each user to enter their identification information and change the settings.

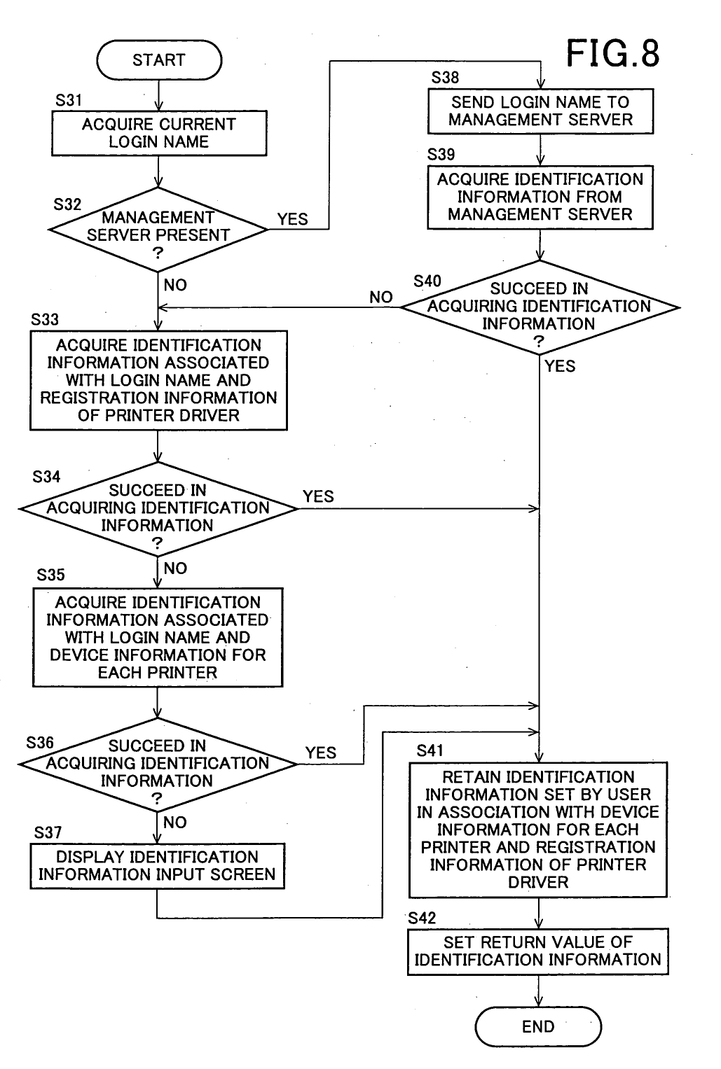

FIG. 8 is a flowchart for illustrating another example of the data output method to which the present invention is applied. This example is to illustrate the flow of the identification information setting process by the printer driver 23 shown in FIG. 7. First, the data output apparatus 2 acquires the current login name from the OS unit 21 (Step S31), decides whether a management server 6 is present on the network 3 or not (Step S32), and, if no management server 6 is present on the network 3 (if NO), acquires the identification information associated with the login name and the registration information of the printer driver 23 (Step S33).

Next, the data output apparatus 2 decides whether the acquisition of the identification information has been successful or not (Step S34), and, if the identification information could not have been acquired (if NO), acquires the identification information associated with the login name and the device information for each printer (Step S35). Next, the data output apparatus 2 decides whether the acquisition of the identification information has been successful or not (Step S36), and, if the identification information could not have been acquired (if NO), proceeds to display process of the input screen for identification information (Step S37) and retains the set identification information in association with the device information for each printer and the registration information of the printer driver 23 (Step S41). On the other hand, if, in Steps S34 and S36 described above, the acquisition of the identification information has been successful (if YES), the data output apparatus 2 proceeds to the above-mentioned Step S41.

And, if, in Step S32, a management server apparatus 6 is present on the network 3 (if YES), the data output apparatus 2 sends the login name acquired in Step S31 to the management server apparatus 6 (Step S38), acquires identification information from the management server apparatus 6 (Step S39), decides whether the acquisition of identification information has been successful or not (Step S40), and, if the acquisition of identification information has been successful (if YES), retains the set identification information in association with the device information for each printer and the registration information of the printer driver 23 (Step S41), and sets the return value of the identification information (Step S42). And, if, in Step S40 described above, the identification information has not been acquired (if NO), it proceeds from Step S33.

While the above description of several embodiments focuses mainly on several features of the data output apparatus and system of the present invention, this invention can, as it has been explained as a method of performing each step in the data output apparatus and system, take the form of a data output method. Moreover, similarly to data output apparatus provided with these several features, the present invention can also take the form of a program for making a computer function as a data output apparatus (i.e., printer driver), or the form of a storage medium on which such a program is stored.

Some examples of storage media on which programs or data for realizing the function of data output function of the present invention are stored will be described here. The storage medium could specifically be assumed to be a CD-ROM (-R/-RW), magneto-optical discs, DVD-ROM (-R/-RW/-RAM), floppy disk, hard disk, flash memory, memory card, memory stick, or other various kinds of ROM, RAM, and the like. Storing the programs which enable a computer to perform functions as an apparatus or system of each embodiment of the present invention described thus far and which achieve the function of data output on these storage media and distributing such storage media facilitate the realization of such functions. And, if the above storage medium is mounted on an information processing apparatus such as computers and the programs are read out by the information processing apparatus, or, otherwise, the programs are stored on some storage medium attached to the information processing apparatus and read out as need arises. Thus the function of data output that concerns the present invention can be performed.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

According to the present invention, following effects can be obtained.

Using a single printer driver, the present invention enables setting, for each user, identification information of the user or the group the user belongs to (e.g., department numbers) and at the same time enables the settings information concerning printing of the printer other than the identification information to be shared by multiple users.

Using a single printer driver, the present invention also enables setting, for each user, identification information of the user or the group the user belongs to (e.g., department numbers) and at the same time enables the identification information not to be disclosed to other users via applications.

1. A data output apparatus comprising:
a communications means for communicating with at least one printer; and
a printer driver for establishing settings regarding printing of the printer, wherein
the printer driver includes a user information acquisition means for acquiring user information, an identification information input means for inputting identification information for identifying the user or the group the user belongs to, and an identification information retention means for retaining the inputted identification information in association with the acquired user information, and wherein
the communications means communicates to the printer the identification information retained in the identification information retention means based on user information acquired at the time of printing.

2. The data output apparatus of claim 1, further comprising an application means for executing a specified function, and wherein the identification information retention means retains the identification information in a specified storage area not accessible by the application means.

3. The data output apparatus of claim 1, wherein the identification information retention means retains the identification information in association with device information for each printer and with the user information.

4. The data output apparatus of claim 1, wherein the identification information retention means retains the identification information in association with registration information set in the printer driver and with the user information.

5. The data output apparatus of claim 1, further comprising an application means for executing a specified function, and wherein the printer driver includes an application communication means for communicating to the application means print settings information of the printer with leaving the identification information blank.

6. The data output apparatus of claim 3, wherein the identification information retention means retains the identification information in association with device information for each printer or with registration information of the printer driver at the time of installing the printer driver.

7. The data output apparatus of claim 3, wherein the printer driver includes a means for displaying a screen for the input of identification information at the time of printing in case the identification information retained in the identification information retention means can not be acquired, and wherein the identification information retention means retains the identification information inputted from the screen for each user.

8. The data output apparatus of claim 3, wherein the identification information retention means retains the identification information for each user in association with both device information for each printer and registration information of the printer driver, and wherein in case that the identification information retained in association with the registration information of the printer driver and with the user information can not be acquired, the identification information retention means retains, in association with registration information of the printer driver and with the user information, the identification information retained in association with device information for each printer and with the user information.

9. The data output apparatus of claim 1, wherein the printer driver includes a means for authenticating a user who has the authority of managing the printer and a means for displaying, for the authenticated user, a screen for the input of identification information of all users, and wherein the identification information retention means associates identification information inputted from the screen with the user information and retains the identification information inputted from the screen in association with device information for each printer or with registration information of the printer driver.

10. A data output apparatus comprising:
a printer driver for establishing settings regarding printing of at least one printer; and
an application means for executing a specified function, wherein
the printer driver includes a user information acquisition means for acquiring user information, an identification information input means for inputting identification information for identifying the user or the group the user belongs to, an identification information retention means for retaining the inputted identification information in association with the acquired user information, and an application communication means for communicating to the application means print settings information of the printer with leaving the retained identification information blank.

11. A data output system where a data output apparatus and a management server apparatus are connected to each other comprising:
the data output apparatus provided with a printer driver which communicate with at least one printer and establishes settings regarding printing of the printer; and
the management server apparatus for retaining identification information for each user for identifying the user or the group the user belongs to, wherein
the printer driver includes a means for acquiring user information, a means for sending the acquired user information to the management server apparatus, and a means for acquiring, from the management server apparatus, the identification information corresponding to the user sent information, and wherein
the printer driver acquires, from the management server apparatus, the identification information corresponding to user information acquired at the time of printing and communicates the identification information corresponding to user information to the printer.

12. A data output method using a printer driver which communicate with at least one printer and establishes the settings regarding printing of the printer, wherein the data output method comprising the steps of:
acquiring user information;
inputting identification information for identifying the user or the group the user belongs to;
retaining the inputted identification information in association with the acquired user information; and
communicating the retained identification information to the printer.

13. A data output method using a printer driver which communicates with an application means for executing a specified function and establishes settings regarding printing of at least one printer, wherein the data output method comprising the steps of:
acquiring user information;
inputting identification information for identifying the user or the group the user belongs to;
retaining the inputted identification information in association with the acquired user information; and
communicating to the application means print settings information of the printer with leaving the retained identification information blank.

14. A data output method in a system where a data output apparatus and a management server apparatus are connected to each other and which includes the data output apparatus provided with a printer driver communicating with at least one printer and establishing settings regarding printing of the printer and the management server apparatus retaining, for each user, identification information for identifying the user or the group the user belongs to, wherein the data output method comprising the steps of:
acquiring user information;
sending the acquired user information to the management server apparatus;
acquiring, from the management server, the identification information corresponding to the sent user information; and
communicating to the printer the acquired identification information.

15. A printer driver executing functions as the data output apparatus as defined in claim 1.

16. A printer driver for executing functions as the data output apparatus in the data output system as defined in claim 11.

17. A computer readable storage medium having stored the printer driver as defined in claim 15.
